(19) United States
(12) Patent Application Publication
(10) Pub. No.: US 2006/0104244 A1
(43) Pub. Date: May 18, 2006

(54) IP terminal apparatus and IP communication method

(75) Inventor: Masahiro Kanagawa, Ota-ku (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/260,465

(22) Filed: Oct. 28, 2005

(30) Foreign Application Priority Data
Nov. 17, 2004 (JP) 2004-333649
Jul. 7, 2005 (JP) 2005-198611

(51) Int. Cl. H04Q 7/00

(52) U.S. Cl. 370/331

(57) ABSTRACT

A card memory stores a home address, a home agent address and the like. When the card memory is attached to an IP terminal apparatus, the IP terminal apparatus retrieves the home address, home agent address and the like stored in the card memory, and automatically transmits to the home agent address of a home agent apparatus a message including the home address and a care-of address generated at the IP terminal apparatus, and requests a registration of the home address and the care-of address.

### BACKGROUND OF THE INVENTION

1. Field of the Invention

The present invention relates to an IP terminal apparatus and an IP communication method. In particular, the present invention relates to an IP terminal apparatus and an IP communication method that are Mobile IPv6-compatible.

2. Description of Related Art

Recently, along with the popularization of the Internet and the widespread use of portable IP terminal apparatuses such as portable personal computers and Internet-compatible portable telephones, there has been an increasing demand for the ability to connect an IP terminal apparatus to the Internet using the same IP address of the IP terminal apparatus even when a user of the IP terminal apparatus uses the IP terminal apparatus at a different location. As an IP communications protocol to address such demand, Mobile IPv6 (Mobile Internet Protocol version 6) has been proposed.

Mobile IPv6 enables an IP terminal apparatus possessing an IPv6 functionality to use one home address no matter which local network on an IPv6 network the IP terminal apparatus moves to, the one home address being an IP address assigned to the IP terminal apparatus from a home network where the IP terminal apparatus usually belongs to. When the IP terminal apparatus has moved to another local network, the IP terminal apparatus generates a care-of address, which is a temporary address for the IP terminal apparatus on the local network to which the IP terminal apparatus has moved, and registers the care-of address into a home agent apparatus, which is a router on the home network. When data are transmitted to the home address of the IP terminal apparatus from another IP terminal apparatus, the data are transmitted once to the home agent apparatus, and then forwarded by the home agent apparatus to the care-of address, thereby making it possible for the IP terminal apparatus to receive the data (Related Art 1).

[Related Art 1] Japanese Patent Laid Open Publication 2003-18193

However, for the above-described Mobile IPv6-compatible IP terminal apparatus, it was necessary for the user of the IP terminal apparatus to input the home address into the IP terminal apparatus when registering the care-of address and the home address into the home agent apparatus. Further, it was also necessary for the user of the IP terminal apparatus to input a home agent address into the IP terminal apparatus, which is the address of the home agent apparatus. These IPv6 addresses are long addresses each having 128 bits, and the input of such long addresses is a cumbersome operation that a user was forced to perform.

### SUMMARY OF THE INVENTION

The present invention is provided to address the above-described problem. The purpose of the present invention is to provide an IP terminal apparatus and an IP communication method that can reduce the burden on a user by enabling an automatic registration of the IPv6 addresses into the home agent apparatus when the Mobile IPv6-compatible IP terminal apparatus moves to a different local network.

The IP terminal apparatus according to the present invention includes a care-of address generator, a memory media attachment/detachment detector and a registration requester. The care-of address generator generates a care-of address on a local network, to which the IP terminal apparatus is currently connected, the local network being among a plurality of local networks of an IPv6 network. The memory media attachment/detachment detector detects an attachment or a detachment of a memory media, the memory media storing a home address assigned from a home network and a home agent address of a home agent apparatus on the home network, the home network being among the plurality of local networks. When the memory media attachment/detachment detector detects that the memory media is attached, the registration requester transmits, to the home agent address stored in the memory media, the care-of address generated by the care-of address generator and the home address stored in the memory media, and requests registration of them into the home agent apparatus.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 shows a configuration of an IP communications system according to an embodiment of the present invention;

FIG. 2 is a block diagram showing configurations of an IP terminal apparatus and a memory card according to the embodiment;

FIG. 3 is a block diagram describing a configuration of a home agent apparatus according to the embodiment;

FIG. 4 shows a table in a cache memory of a home agent apparatus according to the embodiment;

FIG. 5 shows the configuration of a “binding update” message transmitted to a home agent apparatus by an IP terminal apparatus according to the embodiment;

FIG. 6 is a flow chart describing registration-related operations performed by an IP terminal apparatus according to the embodiment;

FIG. 7 is a flow chart describing registration-related operations performed by a home agent apparatus according to the embodiment;

FIG. 8 is a flow chart describing operations performed by a home agent apparatus during a data communications process according to the embodiment;

FIG. 9 is a flow chart describing operations performed by an IP terminal apparatus according to the embodiment when registration data are deleted;

FIG. 10 is a flow chart describing operations performed by a home agent apparatus according to the embodiment when registration data are deleted;

FIG. 11 is a sequence diagram describing a series of operations performed by an IP terminal apparatus and a home agent apparatus according to the embodiment;

FIG. 12 is another sequence diagram describing a series of operations performed by an IP terminal apparatus and a home agent apparatus according to the embodiment; and

FIG. 13 shows an example of an installation of a Mobile IPv6 program according to another embodiment of the present invention.

### DETAILED DESCRIPTION OF PREFERRED EMBODIMENTS

The embodiments of the present invention are explained in detail in the following with reference to the above-described drawings.

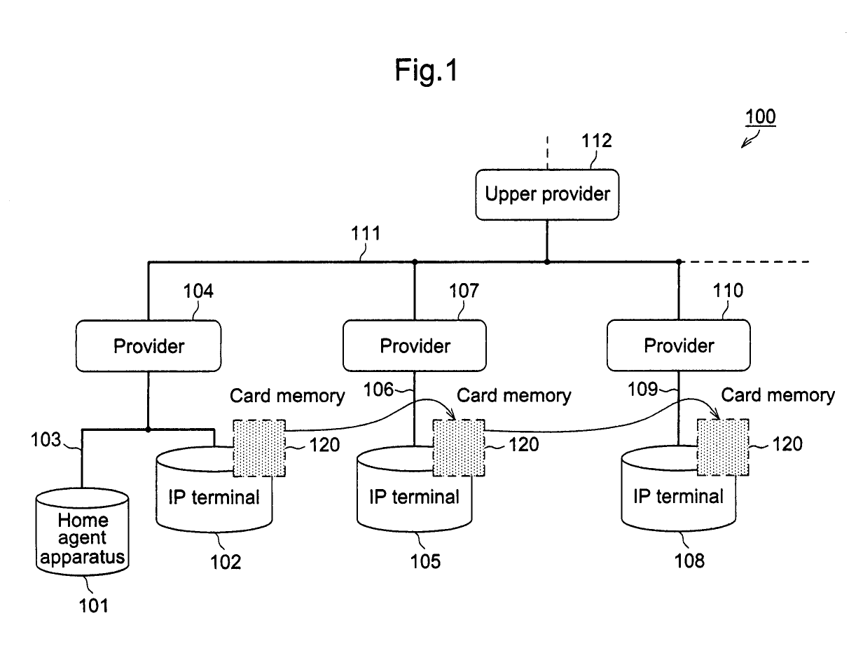

FIG. 1 shows an entire configuration of an IP communications system according to the present embodiment. As FIG. 1 shows, in IP communications system 100, internet service providers (hereafter referred to as “providers”) 104, 107 and 110 are connected to upper provider 112 via IP network 111. Provider 104 is connected to home agent apparatus 101 and IP terminal apparatus (hereafter referred to as “IP terminal”) 102 via local network 103. Provider 107 is connected to IP terminal 105 via local network 106. Provider 110 is connected to IP terminal 108 via local network 109.

IP terminals 102, 105 and 108 are Mobile IPv6-compatible terminals including fixed-wired terminals and mobile terminals. A user can move among local networks 103, 106 and 109, and can use each of IP terminals 102, 105 and 108.

In the present embodiment, among providers 104, 107 and 110, provider 104 is the provider that the user subscribes to. Among local networks 103, 106 and 109, local network 103 is the home network, which is the local network that the user usually belongs to. The user uses a home address which is an IP address assigned by provider 104.

And, when IP terminals 102, 105 and 108 are respectively connected to local networks 103, 106 and 109, each of IP terminals 102, 105 and 108 automatically generates a care-of address. The care-of addresses of IP terminals 102, 105 and 108 are temporary IP addresses on local networks 103, 106 and 109 respectively.

Home agent apparatus 101 is a Mobile IPv6 compatible router and stores the home address of the user and the care-of address of the IP terminal that the user is currently using, and the like. When data are transmitted to the home address from other IP terminals, home agent apparatus 101 receives the data and forwards the data to the care-of address corresponding to the home address; thereby, the user, who is currently using one of IP terminals 102, 105 or 108, receives the data. When the user transmits data to an intended IP terminal from one of IP terminals 102, 105 or 108, the data are also transmitted once to home agent apparatus 101, and then the data are forwarded by home agent apparatus 101 to the intended IP terminal. The IP address of home agent apparatus 101 is called a home agent address.

Portable card memory 120 is attachable to and detachable from each of IP terminals 102, 105 and 108. The same card memory 120 is attachable all IP terminals 102, 105 and 108. Card memory 120 stores the home address of a user, the home agent address, the period of validity of card memory 120, and the like. When the user attaches card memory 120 to IP terminal 102, 105 or 108, IP terminal 102, 105 or 108 transmits, to the home agent address stored in card memory 120, the generated care-of address and the home address stored in card memory 120, and requests registration of the transmitted data into home agent apparatus 101.

When the user has finished a communication using IP terminal 102, 105 or 108 and is about to detach card memory 120, IP terminal 102, 105 or 108 transmits to home agent apparatus 101 a request for the deletion of registered data.

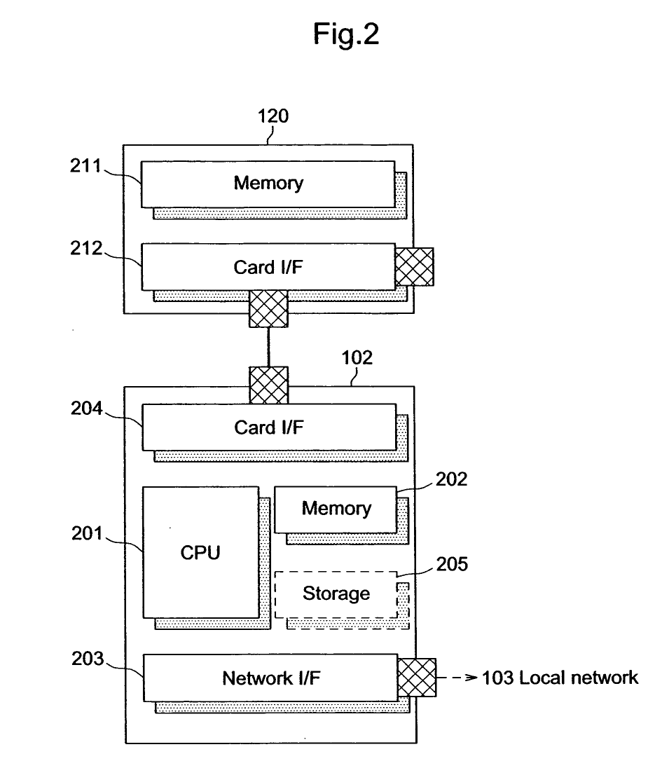

FIG. 2 is a block diagram showing the configurations of IP terminal 102 and card memory 120. FIG. 2 shows the case in which card memory 120 is connected to IP terminal 102. IP terminals 105 and 108 have the same configurations as IP terminal 102.

Card memory 120 includes memory 211 and card interface (hereafter referred to as “card I/F”) 212.

Memory 211 stores the home address of the user, the home agent address, the period of validity of card memory 120 and the like.

Card I/F 212 is an interface for detachably attaching card memory 120 to IP terminal 102. A PCMCIA (Personal Computer Memory Card International Association) slot of a slot-in type, a USB (Universal Serial Bus) connector of a cable type, and the like are applicable as card I/F 212.

On the other hand, IP terminal 102 includes CPU 201, memory 202, network interface (hereafter referred to as “network I/F”) 203, card interface (hereafter referred to as “card I/F”) 204 and storage 205.

CPU (Central Processing Unit) 201 controls the components of IP terminal 102, according to a Mobile IPv6 communications control program and the like stored in memory 202. When network I/F 203 is connected to local network 103, CPU 201 obtains from provider 104 a prefix and an ISP address, and, by adding the MAC address specified on the IP terminal to the prefix and the ISP address, automatically generates a care-of address, and stores the care-of address in memory 202.

Card I/F 204 is an interface for detachably attaching card memory 120 to IP terminal 102. Same as for card I/F 212 of card memory 120, a PCMCIA (Personal Computer Memory Card International Association) slot of a slot-in type, a USB (Universal Serial Bus) connector of a cable type, and the like are applicable as card I/F 204. And, card I/F 204 has a release mechanism (not shown in the figures), such as a switch, for releasing an attached card memory 120 from a being-attached state. By operating the release mechanism, the user detaches card memory 120 from the being-attached state. Further, card I/F 204 electrically detects that the release mechanism has been operated, and outputs to CPU 201 a disconnection notification signal.

Memory 202 stores a Mobile IPv6 communications control program and the like for making an IP terminal Mobile IPv6 compatible. When card memory 120 is attached to IP terminal 102, CPU 201 retrieves the home address, the home agent address, the period of validity and the like, which are stored in memory 211 of card memory 120, and stores the data in memory 202. Memory 202 is also used as a work memory when CPU 201 executes programs.

Network I/F 203 is an interface to local network 103, to which IP terminal 102 is connected. Under the control of CPU 201, network I/F 203 performs communications via local network 103. Network I/F 203 also transmits, to home agent apparatus 101 via local network 103, a message including the home address, the care-of address and the period of validity of card memory 120, the data included in the message being stored in memory 202. Further, when card memory 120 is released from the being-attached state, network I/F 203 transmits, to home agent apparatus 101 via local network 103, a message requesting the deletion of the data stored in home agent apparatus 101.

Storage 205 is a high-capacity storage medium such as a hard disk drive. Storage 205 stores data received from other IP terminals, contents data (such as music data and image data) downloaded through provider 104 from contents web servers (not shown in the figures), and the like. In FIG. 2, storage 205 is drawn with dashed lines to indicate that storage 205 can be either a built-in component of IP terminal 102 or an external unit which is connected through card I/F 212 (a USB connector, for example) of card memory 120.

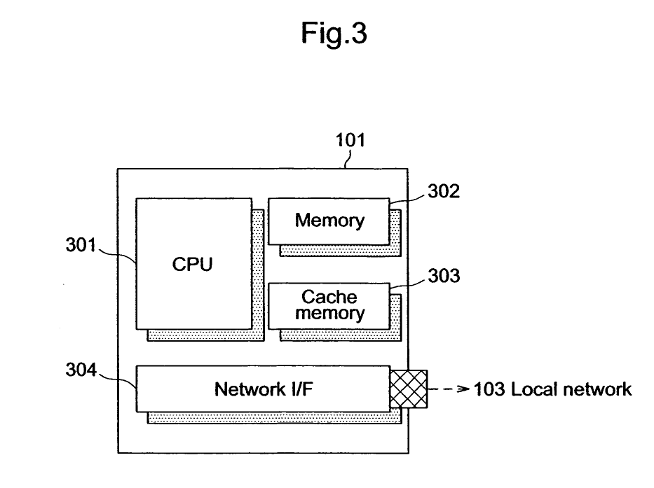

FIG. 3 is a block diagram showing a configuration of home agent apparatus 101. As FIG. 3 shows, home agent apparatus 101 includes CPU 301, memory 302, cache memory 303 and network I/F 304.

CPU 301 controls the components of home agent apparatus 101 according to a home agent control program stored in memory 302.

Network I/F 304 is an interface to local network 103, to which home agent apparatus 101 is connected. Network I/F 304 performs communications via local network 103.

Memory 302 stores the home agent control program and the like, as well as the home agent address and the like. Memory 302 is also used as a work memory when CPU 301 executes programs.

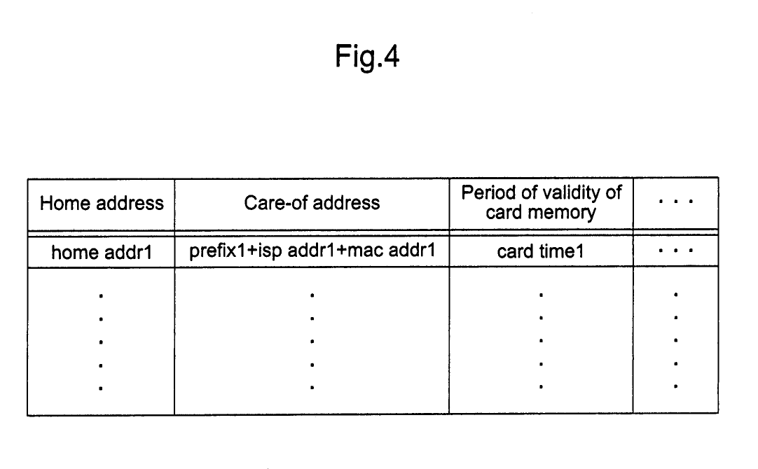

Cache memory 303 has a table shown in FIG. 4. Under the control of CPU 301, cache memory 303 stores data received from IP terminal 102, which includes the home address, the care-of address, the period of validity of card memory 120, and the like.

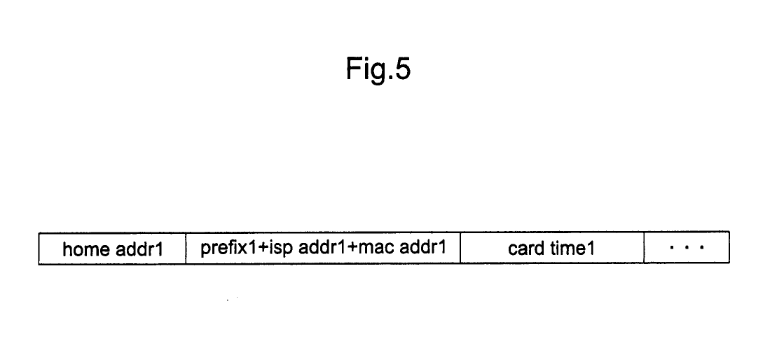

FIG. 5 shows the configuration of a “Binging Update” message transmitted from IP terminal 102 to home agent apparatus 101 when IP terminal 102 requests registration of data into home agent apparatus 101. As FIG. 5 shows, the “Binging Update” message includes the home address, the care-of address, the period of validity of card memory 120, and the like.

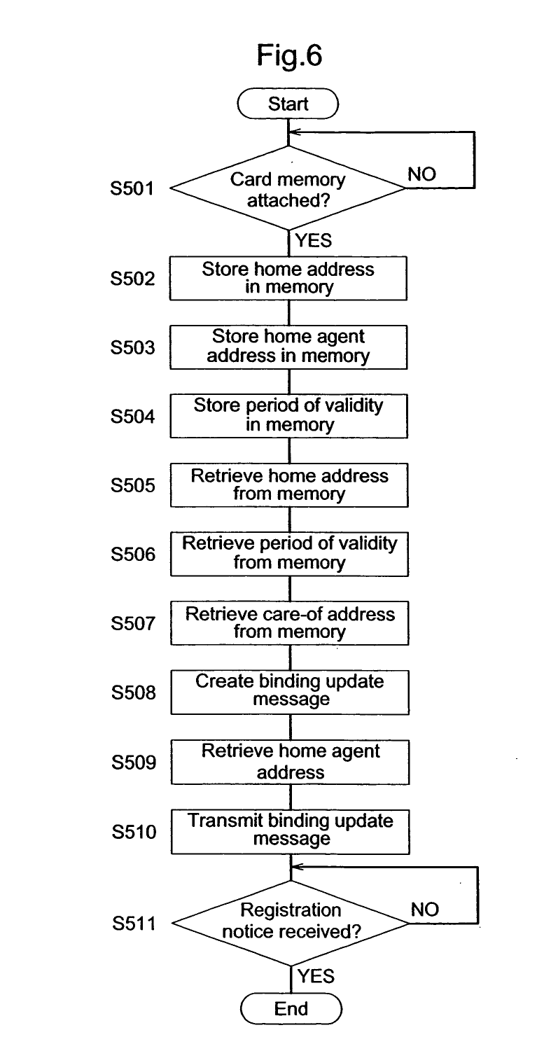

Next, in IP communications system 100 shown in FIG. 1, the operations performed by IP terminal 102 when card memory 120 is attached to IP terminal 102 will be explained with reference to the flow chart shown in FIG. 6.

To explain the operations shown in FIG. 6, it is assumed that a home address, a home agent address and a period of validity of card memory 120 have been stored in card memory 120. It is also assumed that a care-of address has been stored in memory 202 of IP terminal 102.

CPU 201 monitors card I/F 204 until card memory 120 is attached to IP terminal 102 (S501).

Upon confirming that card memory 120 has been attached to IP terminal 102, CPU 201 retrieves the home address from memory 211 of card memory 120 and stores the home address in memory 202 (S502). Next, CPU 201 retrieves the home agent address from memory 211 and stores the home agent address in memory 202 (S503). Further, CPU 201 retrieves the period of validity of card memory 120 from memory 211 and stores the period of validity of card memory 120 in memory 202 (S504).

CPU 201 then retrieves the home address from memory 202 (S505) and retrieves the period of validity from memory 202 (S506). CPU 201 also retrieves the care-of address from memory 202 (S507). Here the care-of address was generated beforehand and has been stored in memory 202.

CPU 201 creates a “binding update” message including the retrieved home address, period of validity and care-of address (S508), retrieves the home agent address from memory 202 (S509), and transmits to the home agent address the “binding update” message (S510).

After receiving the “binding update” message and storing the home address, the care-of address and the period of validity, home agent apparatus 101 transmits to IP terminal 102 a registration notification. Until the registration notification is received, CPU 201 monitors network I/F 203 (S511), and then terminates the process upon receiving the registration notification.

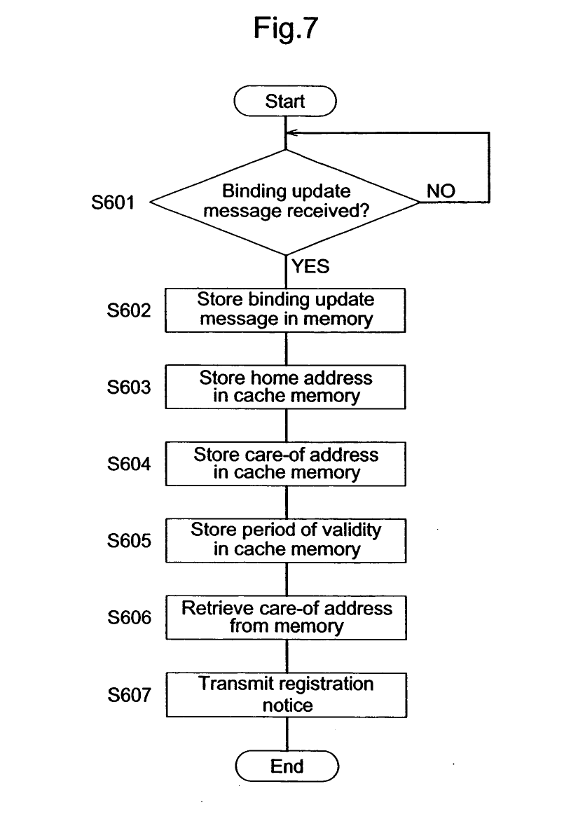

Next, the operations performed by home agent apparatus 101 corresponding to the operations performed by IP terminal 102 shown in FIG. 6 will be explained with reference to the flow chart shown in FIG. 7.

CPU 301 of home agent apparatus 101 monitors network I/F 304 until a “binding update” message is received (S601). Upon confirming that a “binding update” message has been received, CPU 301 stores the “binding update” message in memory 302 (S602).

Next, CPU 301 retrieves the home address included in the “binding update” message from memory 302 and stores the home address in the table of cache memory 303 (S603). CPU 301 then retrieves the care-of address from memory 302 and stores the care-of address in the table of cache memory 303 (S604). CPU 301 further retrieves the period of validity of card memory 120 from memory 302 and stores the period of validity in the table of cache memory 303 (S605). The registration process including the steps of S603-S605 is referred to as a “binding cache” process.

Upon completing the “binding cache” process, CPU 301 retrieves again the care-of address from memory 302 (S606), transmits to the care-of address a registration notification which indicates the registration process has been completed (S607), and terminates the process.

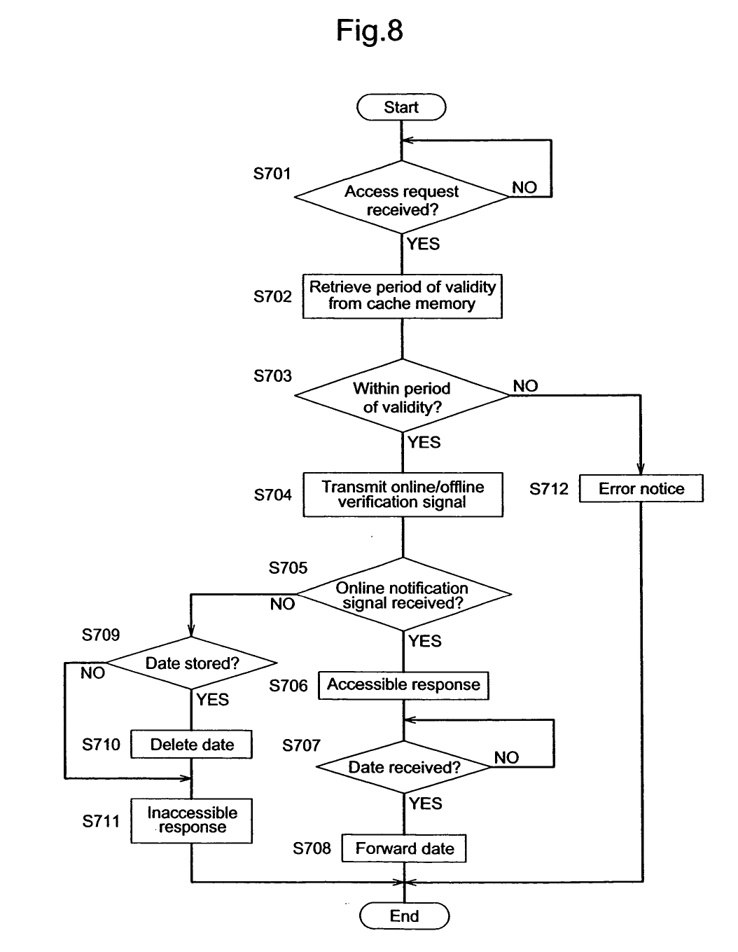

Next, the operations performed by home agent apparatus 101 when another IP terminal transmits data to IP terminal 102 will be explained with reference to the flow chart shown in FIG. 8.

CPU 301 of home agent apparatus 101 monitors network I/F 304 until an access request is received from another IP terminal (S701). Upon confirming that an access request has been received, CPU 301 searches for an entry of IP terminal 102 in cache memory 303 according to the home address of IP terminal 102 contained in the access request, and retrieves the period of validity of card memory 120 corresponding to the home address of IP terminal 102, IP terminal 102 being the destination of the access request (S702). CPU 301 then determines whether card memory 120 is within the period of validity (S703).

When card memory 120 is within the period of validity, home agent apparatus 101 transmits an online/offline verification signal to the care-of address of IP terminal 102, IP terminal 102 being the destination of the access request (S704). When IP terminal 102 is online, IP terminal 102 receives the online/offline verification signal and transmits to home agent apparatus 101 an online notification signal. CPU 301 determines whether the online notification signal has been received (S705).

Upon receiving the online notification signal, CPU 301 transmits to the IP terminal, which originated the access request, a response indicating that IP terminal 102 is accessible (S706). CPU 301 monitors network I/F 304 until data are received from the originator of the access request (S707). Upon confirming that data have been received, CPU 301 forwards the data to the care-of address of IP terminal 102, which is the destination of the access request (S708), and then terminates the process.

In the case where no online notification signal is received at step S705, which indicates that IP terminal 102 is offline, CPU 301 first determines whether there are data associated with IP terminal 102 stored in cache memory 303 (S709). In the case where there are data associated with IP terminal 102 stored in cache memory 303, CPU 301 deletes the data from cache memory 303 (S710). CPU 301 then transmits to the originator of the access request a response indicating that IP terminal 102 is inaccessible (S711), and terminates the process.

In the case where it is determined at step S703 that card memory 120 is not within the period of validity, CPU 301 transmits an error notification to the originator of the access request (S712), and terminates the process.

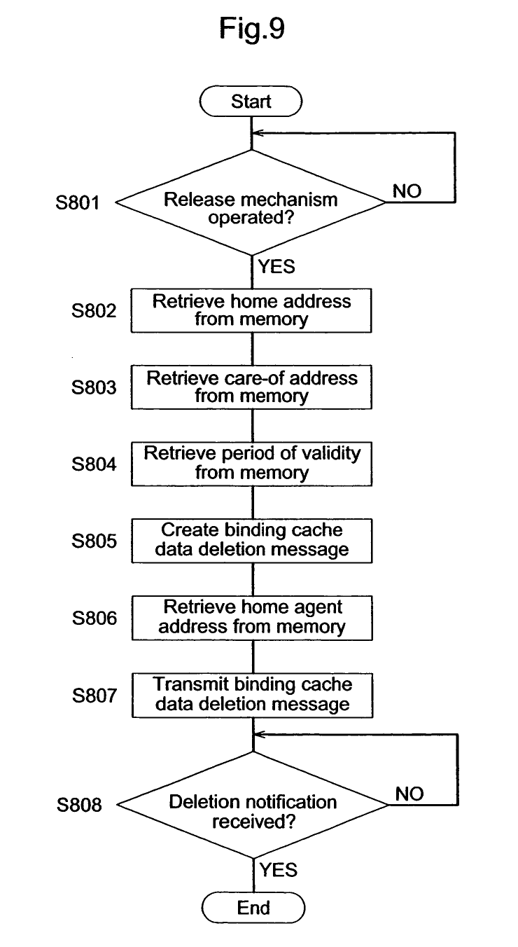

Next, the operations performed by IP terminal 102 when card memory 120 is detached from IP terminal 102 will be explained using the flow chart shown in FIG. 9.

CPU 201 monitors card I/F 204 until the release mechanism of card I/F 204 is operated (S801). When CPU 201 determines that the release mechanism has been operated, CPU 201 retrieves the home address from memory 202 (S802), retrieves the care-of address from memory 202 (S803), and retrieves the period of validity from memory 202 (S804).

CPU 201 creates a “binding cache data deletion” message including the retrieved home address, care-of address and period of validity (S805), retrieves the home agent address from memory 202 (S806), and transmits to the home agent address the “binding cache data deletion” message (S807). Home agent apparatus 101 receives the “binding cache data deletion” message, deletes the stored data associated with IP terminal 102, and transmits to IP terminal 102 a deletion notification. CPU 201 monitors network I/F 203 until the deletion notification is received (S808). Upon confirming that the deletion notification has been received, CPU 201 terminates the process, after which card memory 120 can be detached.

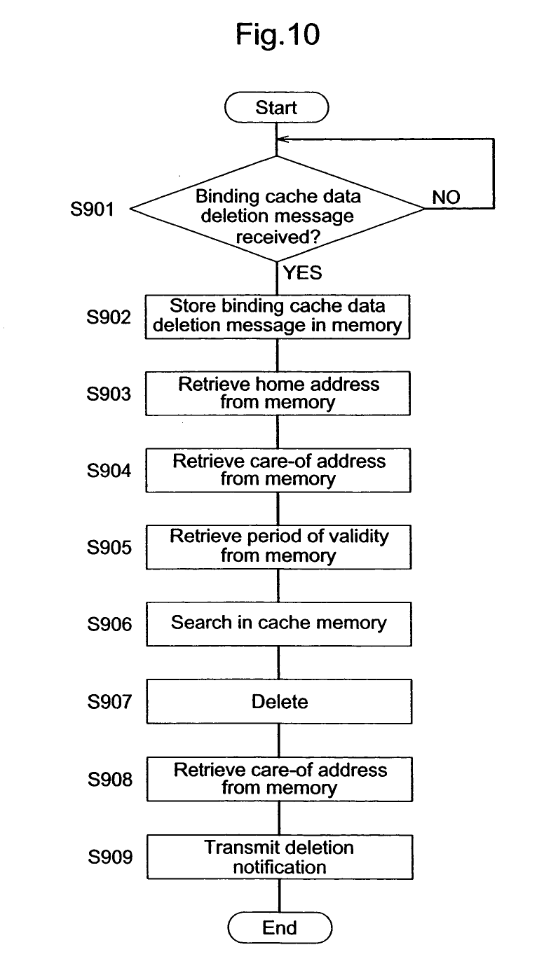

Next, the operations performed by home agent apparatus 101 corresponding to the operations performed by IP terminal 102 shown in FIG. 9 will be explained using the flow chart of FIG. 10.

CPU 301 monitors network I/F 304 until a “binding cache data deletion” message is received (S901). Upon confirming that a “binding cache data deletion” message has been received, CPU 301 stores the “binding cache data deletion” message in memory 302 (S902).

CPU 301 retrieves the home address from memory 302 (S903), retrieves the care-of address from memory 302 (S904), and retrieves the period of validity of card memory 120 from memory 302 (S905).

CPU 301 searches cache memory 303 for a corresponding entry, according to the retrieved home address, care-of address and period of validity (S906), and deletes the corresponding entry (S907).

After the deletion, CPU 301 retrieves again from memory 302 the care-of address (S908), transmits to the care-of address a deletion notification (S909), and terminates the process.

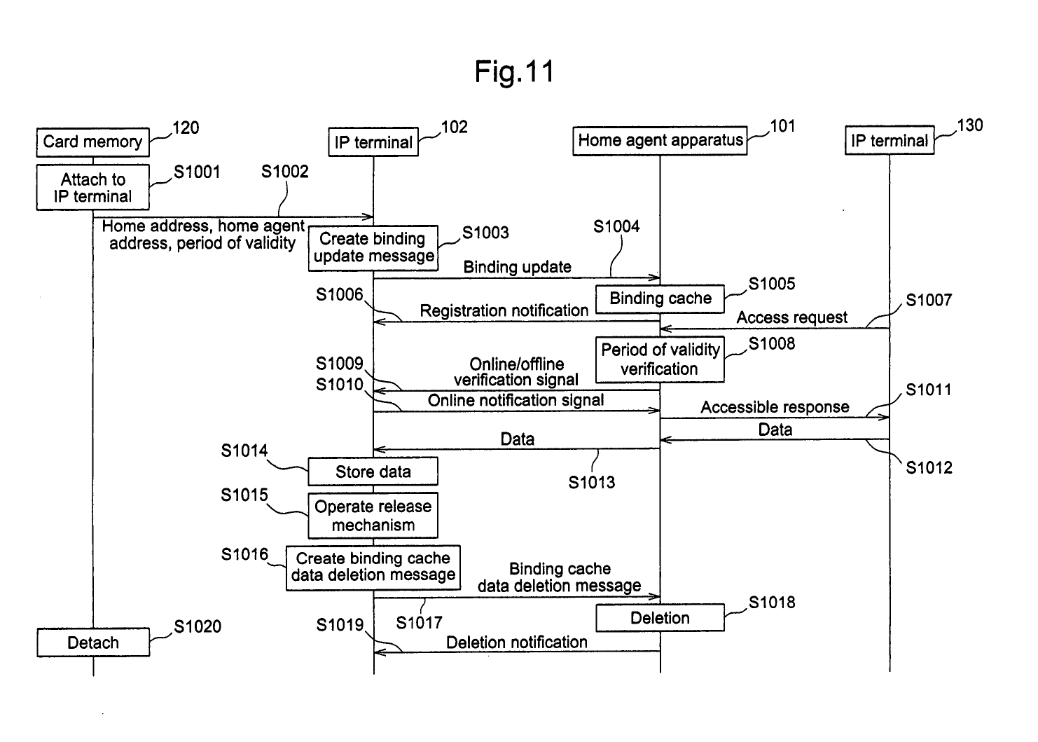

Next, a process, which begins with attaching card memory 120 to IP terminal 102 and ends with detaching card memory 120 from IP terminal 102 and in the middle of which data are transmitted to IP terminal 102 from another IP terminal 130, will be considered, and the operations performed by card memory 120, IP terminal 102, home agent apparatus 101 and IP terminal 130 during the process will be explained using the sequence shown in FIG. 11.

Card memory 120 is attached to IP terminal 102 (S1001), and IP terminal 102 retrieves from memory 211 of card memory 120 the home address, home agent address and period of validity of card memory 120 (S1002). IP terminal 102 creates a “binding update” message (S1003) and transmits the “binding update” message to the home agent address of home agent apparatus 101 (S1004). Home agent apparatus 101 performs a “binding cache” to store data associated with IP terminal 102 (S1005), and transmits to IP terminal 102 a registration notification (S1006).

Another IP terminal 130 transmits, to home agent apparatus 101, an access request to access IP terminal 102 (S1007). The access request includes the home address of IP terminal 102. Home agent apparatus 101 references cache memory 303 using the home address of IP terminal 102 and verifies the period of validity of card memory 120 attached to IP terminal 102 (S1008). Upon determining that card memory 120 is within the period of validity, home agent apparatus 101 transmits to the care-of address of IP terminal 102 an online/offline verification signal (S1009). IP terminal 102 receives the online/offline verification signal and transmits to home agent apparatus 101 an online notification signal (S1010). Home agent apparatus 101 transmits to IP terminal 130 a response indicating that IP terminal 102 is accessible (S1011).

When IP terminal 130 transmits data to the home address of IP terminal 102 (S1012), home agent apparatus 101 receives the data and forwards the data to the care-of address corresponding to the home address (S1013). IP terminal 102 receives the data and stores the data in memory 202 (S1014).

When the release mechanism of card I/F 204 of IP terminal 102 is operated (S1015), IP terminal 102 creates a “binding cache data deletion” message (S1016), and transmits to home agent apparatus 101 the “binding cache data deletion” message (S1017). Home agent apparatus 101 receives the “binding cache data deletion” message, deletes the data associated with IP terminal 102 stored in cache memory 303 (S1018), and transmits to IP terminal 102 a deletion notification (S1019).

After IP terminal 102 receives the deletion notification, card memory 120 is detached from IP terminal 102 by the user (S1020), after which the process is terminated.

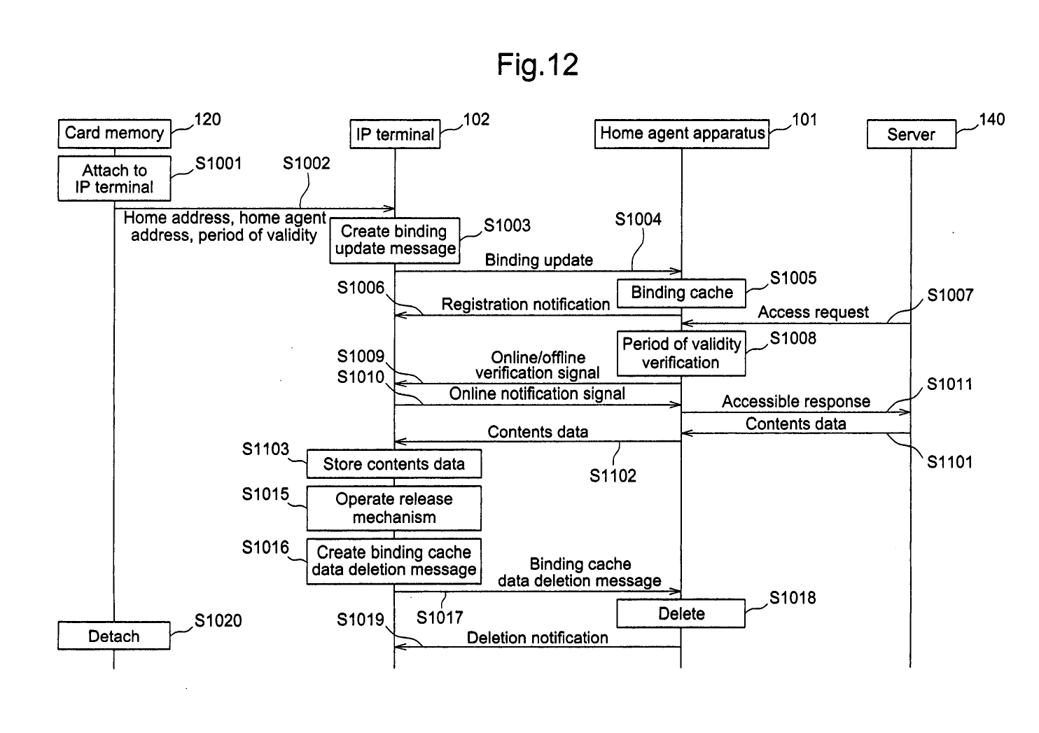

In the present embodiment, the case where IP terminal 102 receives data from another IP terminal 103 has been explained. As FIG. 12 shows, IP terminal 102 can also download content from server 140. In FIG. 12, the operations that are the same as in FIG. 11 are assigned with the same symbols and their explanations are omitted.

Server 140 transmits regularly contents data such as music. Server 140 transmits contents data to the home address of IP terminal 102 (S1101). Home agent apparatus 101 receives the contents data and forward the contents data to the care-of address corresponding to the home address (S1102). IP terminal 102 receives the contents data and stores the contents data in storage 205 (S1103).

In the embodiment described above, the operations performed by IP terminal 102 and home agent apparatus 101 are mainly explained. However, it is also possible for IP terminals 105 and 108 to perform the same operations.

The embodiment described above shows a case where a Mobile IPv6 communications control program is installed in each of IP terminals 102, 105 and 108. However, it is also possible to have the Mobile IPv6 communications control program stored in a card memory and install the Mobile IPv6 communications control program to an IP terminal when the card memory is attached to the IP terminal.

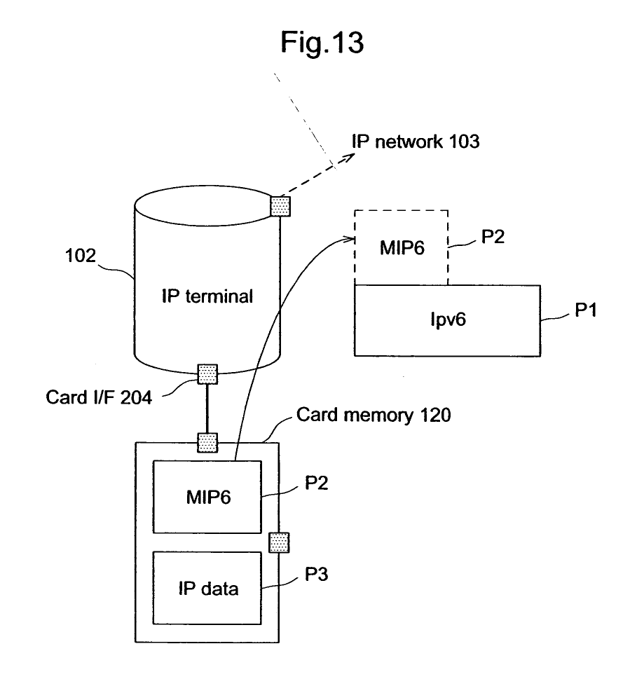

This example is shown in FIG. 13. In FIG. 13, card memory 120 stores Mobile IPv6 communications control program (MIP6) P2 and IP data P3 such as the home address and home agent address. IP terminal 102 stores IPv6 communications control program P1. When card memory 120 is attached to card I/F 204 of IP terminal 102, IP terminal 102 retrieves from card memory 120 Mobile IPv6 communications control program (MIP6) P2 and installs Mobile IPv6 communications control program (MIP6) P2 in an internal memory (not shown in the figure). As a result of the installation, as the figure shows, Mobile IPv6 communications control program (MIP6) P2 is stacked on top of IPv6 communications control program P1 in the IP terminal.

Therefore, for IP terminal 102 having only an IPv6 communications control program installed therein, it is also possible for IP terminal 102 to perform as a Mobile IPv6-compatible IP terminal by attaching to IP terminal 102 card memory 120 containing a Mobile IPv6 communications control program and installing the Mobile IPv6 communications control program to IP terminal 102.

As described above, in IP communications system 100 according to the present embodiment, by the use of card memory 120 storing a home address, a home agent address and the like, a registration of the home address, the home agent address and the like into home agent apparatus 101 is performed automatically. Therefore, the user does not have to input the home address, the home agent address and the like on an IP terminal.

Further, a period of validity of card memory 120 is stored in card memory 120, thereby making it possible to prevent the use of a card memory that has past the period of validity.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2004-333649 filed on Nov. 17, 2004 and the Japanese Patent Application No. 2005-198611 filed on Jul. 7, 2005 entire content of which is expressly incorporated by reference herein.

What is claimed is:

1. An IP terminal apparatus operating according to a mobile IPv6 protocol and being connected to a home agent apparatus via a local network, the IP terminal apparatus comprising:
a memory slot configured to receive a memory card, the memory card storing an IP address of the home agent apparatus and a home address assigned to a user of the memory card; and
a controller configured to:
generate a care-of address of the IP terminal apparatus; and
transmit, to the home agent apparatus based on the IP address of the home agent apparatus stored in the memory card, a predetermined message for storing, in the home agent apparatus, the home address stored in the memory card and the generated care-of address of the IP terminal apparatus, whereby the home agent apparatus can store the care-of address of the IP terminal apparatus corresponding to the home address.

2. The IP terminal apparatus according to claim 1, wherein when the home agent apparatus receives, from another IP terminal apparatus, a request for accessing the home address, the home agent apparatus transfers, to the IP terminal apparatus, data received from the another IP terminal apparatus, based on the care-of address of the IP terminal apparatus corresponding to the home address.

3. The IP terminal apparatus according to claim 1 being further connected to an Internet service provider via the local network, wherein the Internet service provider assigns the home address to the user of the memory card.

4. The IP terminal apparatus according to claim 1 being further connected to an Internet service provider via the local network, the Internet service provider providing a prefix and an ISP address to the IP terminal apparatus when the IP terminal apparatus is connected to the local network, wherein the controller generates the care-of address of the IP terminal apparatus, based on the prefix, the ISP address and a MAC address, the MAC address being assigned to the IP terminal apparatus.

5. The IP terminal apparatus according to claim 1, wherein the memory card further stores a period of validity of the memory card, and the controller further transmits, to the home agent apparatus, the predetermined message for storing, in the home agent apparatus, the period of validity of the memory card, whereby the home agent apparatus can store the period of validity of the memory card corresponding to the home address.

6. The IP terminal apparatus according to claim 5, wherein when the home agent apparatus receives, from another IP terminal apparatus, a request for accessing the home address, the home agent apparatus checks the period of validity of the memory card corresponding to the home address and transfers, to the IP terminal apparatus, data received from the another IP terminal apparatus, based on the care-of address of the IP terminal apparatus corresponding to the home address, when the period of validity of the memory card has not elapsed.

7. The IP terminal apparatus according to claim 1, wherein when the controller detects removal of the memory card from the memory slot, the controller transmits, to the home agent apparatus, another predetermined message for deleting, from the home agent apparatus, the care-of address of the IP terminal apparatus and the home address.

8. The IP terminal apparatus according to claim 1 further comprising a memory, wherein the memory card stores a predetermined program for controlling an IP v6 communication, and the controller moves the predetermined program from the memory card into the memory of the IP terminal apparatus when the memory card is installed in the memory slot.

9. A method for performing a communication using an IP terminal apparatus operating according to a mobile IPv6 protocol, the IP terminal apparatus being connected to a home agent apparatus via a local network, the method comprising:
receiving a memory card into a memory card of the IP terminal apparatus, the memory card storing an IP address of the home agent apparatus and a home address assigned to a user of the memory card;
generating, at the IP terminal apparatus, a care-of address of the IP terminal apparatus;
transmitting, to the home agent apparatus based on the IP address of the home agent apparatus stored in the memory card, a predetermined message for storing, in the home agent apparatus, the home address stored in the memory card and the generated care-of address of the IP terminal apparatus; and
storing, in the home agent apparatus, the care-of address of the IP terminal apparatus corresponding to the home address.
